(19) United States
(12) Patent Application Publication
(10) Pub. No.: US 2026/0212661 A1
(43) Pub. Date: Jul. 23, 2026

(54) METHOD AND APPARATUS WITH VISION TRANSFORMER MODEL

(71) Applicant: Samsung Electronics Co., Ltd., Suwon-si (KR)

(72) Inventors: Chanho AHN, Suwon-si (KR); Kikyung KIM, Suwon-si (KR); Saehyun AHN, Suwon-si (KR)

(73) Assignee: Samsung Electronics Co., Ltd., Suwon-si (KR)

(21) Appl. No.: 19/421,557

(22) Filed: Dec. 16, 2025

(30) Foreign Application Priority Data
Jan. 20, 2025 (KR) 10-2025-0007914

(51) Int. Cl. G06V 10/82; G06V 10/32; G06V 10/72; G06V 10/764; G06V 10/774; G06V 10/776

(52) U.S. Cl. CPC G06V 10/82; G06V 10/32; G06V 10/72; G06V 10/764; G06V 10/7747; G06V 10/776

(57) ABSTRACT

A processor-implemented method includes removing one or more patch images from an original image comprising a plurality of patch images to generate a transformed image, and training a transformer model to minimize a value of a loss function for a difference between a result of inputting the original image and a result of inputting the transformed image.

### CROSS-REFERENCE TO RELATED APPLICATIONS

This application claims priority to and the benefit under 35 USC § 119(a) of Korean Patent Application No. 10-2025-0007914 filed in the Korean Intellectual Property Office on Jan. 20, 2025, the entire disclosure of which is incorporated herein by reference for all purposes.

### BACKGROUND

### 1. Field

The following description relates to a method and apparatus with a vision transformer model.

### 2. Description of Related Art

Artificial intelligence algorithms that perform image-based tasks may achieve superior performance in most tasks with deep learning methods compared to traditional methods, and a transformer model may handle a large amount of learning data and outperform the performance of existing deep learning methods.

Existing image-based deep learning methods (CNN), which emphasize the importance of dense areas, may adopt a method of global pooling characteristic vectors in the horizontal and vertical directions of the image in the last layer, so that they are not greatly affected by the size or resolution of the input image.

On the other hand, a transformer structure may divide an input image into grid-shaped patches and perform computations based on the similarity between respective patches, and since the size of the image divided into patches is fixed, when the characteristics of the input image are changed, the number of patches, the pattern of similarity, and the like may be transformed, and the performance may be significantly reduced.

That is, the transformer model may divide the image into patch units of a predetermined size and input them to the algorithm. There is a process of transforming the patch image into a single vector (token), so the size of the patch image cannot change.

When a large image is input, the number of patches may increase due to the fixed patch image size. The transformer model may add a position vector (e.g., position embedding) to the vector obtained from the patch to reflect the position information of each patch. In each layer of the transformer model, each patch vector of the next step may be determined as a linear sum weighted by the similarity between the vectors obtained from the patch.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes removing one or more patch images from an original image comprising a plurality of patch images to generate a transformed image, and training a transformer model to minimize a value of a loss function for a difference between a result of inputting the original image and a result of inputting the transformed image.

The removing of one or more patch images from the original image including the plurality of patch images to generate the transformed image may include randomly selecting and removing one or more patch images from the plurality of patch images.

The removing of one or more patch images from the original image comprising the plurality of patch images to generate the transformed image may include sequentially generating a plurality of transformed images having a hierarchical structure, and the hierarchical structure may be a structure in which a higher-level transformed image may include more patch images than a lower-level transformed image and may include all patch images comprised in the lower-level transformed image.

The sequentially generating of the plurality of transformed images having the hierarchical structure may include removing a plurality of patch images from the original image to generate a first level transformed image, and generating a second level transformed image in which one or more patch images are restored from the plurality of patch images removed from the first level transformed image.

The sequentially generating of the plurality of transformed images having the hierarchical structure further may include generating a third level transformed image in which one or more patch images are restored from the plurality of patch images removed from the second level transformed image.

The training of the transformer model that minimizes the value of the loss function for the difference between the result of inputting the original image and the result of inputting the transformed image may include training the transformer model to minimize values of a loss function representing differences between the result of inputting the original image and results of respectively inputting the plurality of transformed images having the hierarchical structure.

The training of the transformer model to minimize the value of the loss function for the difference between the result of inputting the original image and the result of inputting the transformed image may include training a transformer model using an equation E_{I′~T(I)}[L(ƒ(I′),y)], E_{I′~T(I)} may be the average of the loss function obtained by performing patch image removal, I may be the original image, I′ may be the transformed image, L may be the loss function, f may be the result of the transformer model, y may be the label or inference result of the original image, and T may be patch removal-based image transformation.

The method may include outputting a prediction result for an input image using the trained transformer model, wherein the outputting of the prediction result for the input image using the trained transformer model may include determining a patch image removal criterion of an input image based on data about a device, the input image comprising a plurality of patch images, and
removing one or more patch images from the input image according to the determined patch image removal criterion to generate a transformed image, and inputting the transformed image to the trained transformer model to output a prediction result.

In one or more general aspects, a processor-implemented method includes determining a patch image removal criterion of an input image based on data for a device, the input image comprising a plurality of patch images, removing one or more patch images from the input image according to the determined patch image removal criterion to generate a transformed image, and inputting the transformed image into a transformer model to output a prediction result.

The receiving of the input image configured of the plurality of patch images from the device may include respectively receiving the input image from a plurality of devices disposed in a plurality of different processes.

The determining of the patch image removal criterion of the input image based on the data for the device may include determining the patch image removal criterion comprising one or more of the number of removals of patch images and removal positions of patch images among a plurality of patch images of the input image.

The determining of the patch image removal criterion of the input image based on the data for the device may include determining how many patch images to remove based on a memory data limit of the device.

The determining of how many patch images to remove based on the memory data limit of the device may include determining how many patch images to remove using an equation

$$⌈ ( 1 - \sqrt{\frac{m}{M}} ) N ⌉ ,$$

N may be the number of reference patch images, M may be the execution memory for the number of reference patch images, and m may be the memory limit of the device.

The determining of the patch image removal criterion of the input image based on the data for the device further may include determining how many patch images to remove by finding out the number of executable limit patch images of the device while increasing the number of patch images to be removed in response to the device not having the memory data limit.

The determining of the patch image removal criterion of the input image based on the data for the device may include determining the patch image removal criterion comprising any one or any combination of any two or more of a removal number, a removal position, a removal pattern, and a removal method of the patch image, based on prior knowledge data comprising characteristic information previously collected about the device.

The determining of the patch image removal criterion of the input image based on the data for the device may include collecting a difficulty of an inference to be performed by the transformer model in the device as prior knowledge data and determining the number of removals of patch images that is inversely proportional to the difficulty.

The collecting of the difficulty of the inference to be performed by the transformer model in the device as the prior knowledge data and determining the number of removals of the patch images that is inversely proportional to the difficulty may include performing multiple inferences while changing the number of removals of patch images for an arbitrary input image using the transformer model and determining the difficulty based on consistency of predicted results of the inferences, training an image-difficulty classification model for the device based on the determined difficulty, and determining the number of removals of patch images for the input image of the device using the trained input image-difficulty classification model.

The method may include training the transformer model to minimize a value of a loss function for a difference between a first prediction result generated based on an original image comprising a plurality of patch images and a second prediction result generated based on a transformed image generated by removing one or more patch images from the original image.

In one or more general aspects, an apparatus includes one or more processors comprising processing circuitry, and memory comprising one or more storage media storing instructions that, when executed individually or collectively by the one or more processors, cause the electronic device to remove one or more patch images from the input image according to a patch image removal criterion determined for the input image based on data to generate a transformed image, the input image comprising a plurality of patch images and the data comprising either one or both of a memory limit and characteristic prior information of the device, and input the generated transformed image to a transformer model to output a prediction result.

The transformer model may be pre-learned to minimize a value of a loss function for a difference between a first prediction result generated based on an original image comprising a plurality of patch images and a second prediction result generated based on a transformed image generated by removing one or more patch images from the original image.

Other features and aspects will be apparent from the following detailed description, the drawings, and the claims.

### BRIEF DESCRIPTION OF THE DRAWINGS

FIG. 1 illustrates a vision transformer model learning method according to one or more embodiments of the present disclosure.

FIG. 2 illustrates a vision transformer model inference method according to one or more embodiments of the present disclosure.

FIG. 3 illustrates a detached appearance of a patch image according to one or more embodiments of the present disclosure.

FIG. 4 illustrates an original image and a transformed image according to one or more embodiments of the present disclosure.

FIG. 5 illustrates a block diagram of a vision transformer model apparatus according to one or more embodiments of the present disclosure.

FIG. 6 illustrates a flowchart of a vision transformer model learning method according to one or more embodiments of the present disclosure.

FIG. 7 illustrates a flowchart of a vision transformer model inference method according to one or more embodiments of the present disclosure.

FIG. 8 illustrates a flowchart of a vision transformer model learning method according to one or more embodiments of the present disclosure.

FIG. 9 illustrates a flowchart of a vision transformer model inference method according to one or more embodiments of the present disclosure.

FIG. 10 illustrates a flowchart of a vision transformer model inference method according to one or more embodiments of the present disclosure.

FIG. 11A and FIG. 11B illustrate tables of effects of a vision transformer model apparatus and method according to one or more embodiments of the present disclosure.

FIG. 12 is a drawing for explaining a typical vision transformer model.

FIG. 13 is a drawing for explaining a computing device according to one or more embodiments of the present disclosure.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION OF THE EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Embodiments of the present disclosure will be described with reference to the accompanying drawings.

One or more embodiments of the present disclosure attempts to provide a vision transformer model learning and inference method and apparatus that may provide a trade-off between performance and computational efficiency of the model, including a lightweight method of the transformer model.

One or more embodiments of the present disclosure attempts to provide a vision transformer model learning and inference method and apparatus that may learn a transformer model that is robust to computations on a transformed image according to patch image removal-based learning and may perform an image transformation (patch removal) based environmental customization computation reflecting a user's environment (computational resources) through the learned transformer model.

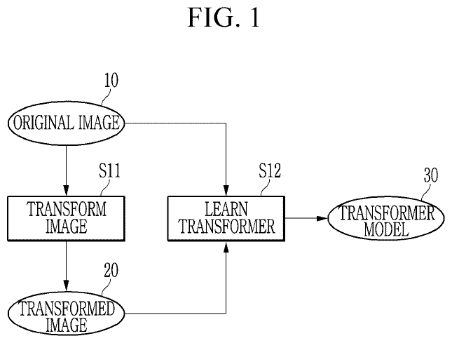

FIG. 1 illustrates a vision transformer model learning method according to one or more embodiments of the present disclosure.

A vision transformer model learning method may include a step of generating a transformed image 20 by removing at least one patch image from an original image 10 including a plurality of patch images (e.g., step S11).

In step S11, at least one patch image may be arbitrarily or randomly selected. Alternatively, a plurality of transformed images may be sequentially generated with a hierarchical structure.

Here, the hierarchical structure may be a structure in which a higher-level transformed image including more patch images includes all patch images included in the lower-level transformed image.

For example, the second level transformed image may include all patch images included in the first level transformed image and may further include several patch images.

In step S11, the first level transformed image, the second level transformed image, and the third level transformed image may be sequentially generated according to the hierarchical structure.

The second level transformed image may be generated by restoring at least one patch image among a plurality of patch images removed from the first level transformed image.

The third level transformed image may be generated by restoring at least one patch image among a plurality of patch images removed from the second level transformed image.

The vision transformer model learning method may include a step of learning a transformer model 30 that minimizes the value of a loss function for the difference between the result of inputting the original image 10 and the result of inputting the transformed image 20 (step S12). As used herein, “learning” a model may mean “training” the model, and the terms may be used interchangeably.

In step S12, the transformer model may learn (e.g., be trained) to minimize values of a loss function representing differences between the result of inputting the original image and the results of respectively inputting a plurality of transformed images having a hierarchical structure.

In addition, the transformer model may be learned using Equation 1 below, for example.

$${E}_{{I}^{′} ∼ T ( I )} [ L ( f ( {I}^{′} ) , y ) ] \qquad Equation 1$$

In Equation 1, E_{I′~T(I)} is the average of the loss function obtained by performing patch image removal, I is the original image, I′ is the transformed image, L is the loss function, f is the result of the transformer model, y is the label or inference result of the original image, and T may mean patch removal-based image transformation.

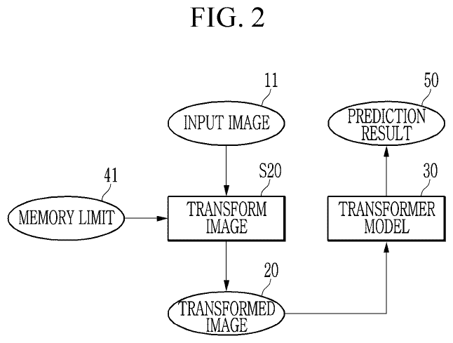

FIG. 2 illustrates a vision transformer model inference method according to one or more embodiments of the present disclosure.

The vision transformer model inference method may include an image transformation step of determining a patch image removal criterion based on a memory limit 41 (e.g., a determined available memory space of a memory) and generating a transformed image 20 by removing at least one patch image from an input image 11 according to the determined patch image removal criterion (e.g., step S20).

The vision transformer model inference method may include a step of inputting the transformed image 20 to the transformer model 30 to output a prediction result 50.

In step S20, the vision transformer model inference method may include receiving an input image configured of a plurality of patch images from a device and determining a patch image removal criterion of the input image based on data for the device.

The input image may be received from a plurality of devices disposed in a plurality of different processes.

The patch image removal criterion may include at least one of the number of removed patch images among a plurality of patch images of the input image and/or the removal position of the patch images.

The patch image removal criterion, including how many patch images to remove, may be determined using Equation 2 below, for example.

$$⌈ ( 1 - \sqrt{\frac{m}{M}} ) N ⌉ \qquad Equation 2$$

In Equation 2, N may be the number of reference patch images, M may be the execution memory to be used for the number of reference patch images, and m may be the memory limit of the device.

When the device does not have a memory data limit, the patch image removal criterion including how many patch images to remove may be determined by finding out the limit of the number of executable patch images of the device while increasing the number of patch images to be eliminated.

The patch image removal criterion may be determined based on prior knowledge data including characteristic information previously collected or determined for the device.

In this case, the patch image removal criterion may include at least one of the number of patch images to be removed, the removal position, the removal pattern, and/or the removal method.

For example, if objects such as defects are centrally aligned in the semiconductor packaging process, patches in the outer portion may be removed instead of removing any (e.g., a random) patch.

The difficulty of the problem to be solved (e.g., an inference to be performed) by the transformer model in the device may be collected as prior knowledge data, and the number of removed patch images may be determined inversely proportional to the difficulty.

The patch image removal criterion may be determined through the learned image-difficulty classification model.

The image-difficulty classification model is learned based on the difficulty.

The difficulty can be determined based on the consistency of the predicted results of the inference by performing multiple inferences while changing the number of removed patch images for an arbitrary input image using the learned transformer model.

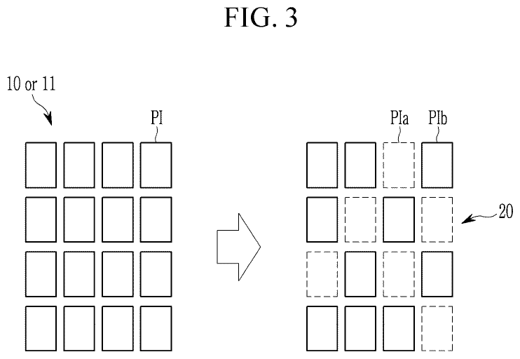

FIG. 3 illustrates a detached appearance of a patch image according to one or more embodiments of the present disclosure.

The original image 10 and/or the input image 11 may include a plurality of patch images PI.

The transformed image 20 may include the remaining patch images Plb and may not include at least one patch image Pla that has been removed from the plurality of patch images PI.

The transformed image 20 may be used for both learning and inference of the transformer model.

For learning, the removing of patch images Pla may be performed randomly or hierarchically.

For inference, the removing of patch images Pla may be performed based on the device's memory limit and/or prior knowledge data.

For example, the patch image removal criterion, including the number of removed patch images Pla, the removal position, the removal pattern, and the like may be determined based on the device's memory limit and/or various prior knowledge data collected about the device.

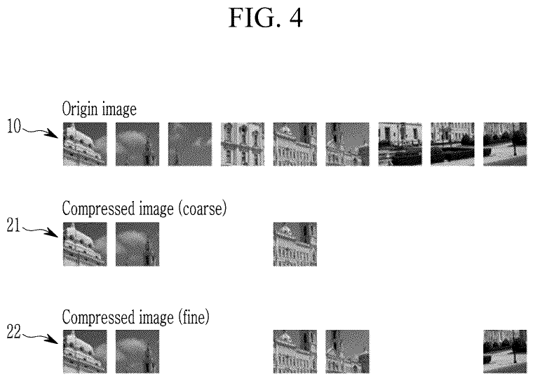

FIG. 4 illustrates an original image and a transformed image according to one or more embodiments of the present disclosure.

FIG. 4 is a drawing for explaining a hierarchical structure.

In FIG. 4, a second level transformed image 22 including five patch images includes all three patch images of a first level transformed image 21, and the first and second level transformed images 21 and 22 have a hierarchical structure.

By utilizing the hierarchical structure in the patch image removing method, two inferences, coarse transformation and fine transformation, may be learned with a single computation. Although two levels are illustrated in FIG. 4, two or more levels may be defined.

With one pass through the transformer model, the result of the original image (Origin image) and the result of only one transformed image (Compressed image) may be compared, whereas, by setting the proposed hierarchical activation step of one or more embodiments, with one pass through the transformer model, the result of the original image and the results of a plurality of transformed images may be compared, allowing learning of more information with the same level of computation.

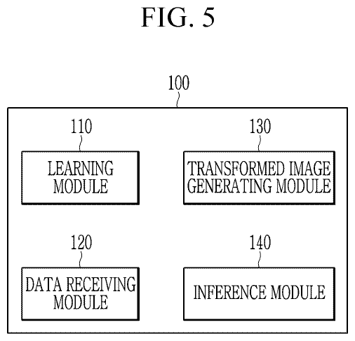

FIG. 5 illustrates a block diagram of a vision transformer model learning and inference apparatus according to one or more embodiments of the present disclosure.

In FIG. 5, a vision transformer model learning and inference apparatus 100 according to one or more embodiments may execute a program code or instruction stored in one or more memory devices through one or more processors.

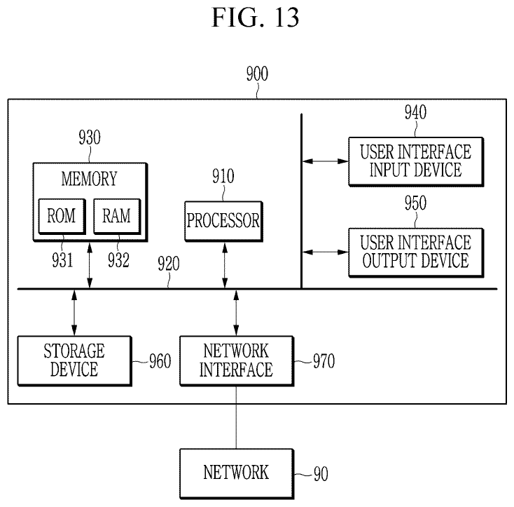

For example, the vision transformer model learning and inference apparatus 100 may be implemented as a computing device 900 as described later with reference to FIG. 13. In this case, one or more processors may correspond to a processor 910 of the computing device 900, and one or more memory devices may correspond to a memory 930 of the computing device 900.

The program code or instructions may be executed by one or more processors to perform appropriate computations according to the variable environment with patch removal-based image transformation reflecting the user's environment including device data and prior information.

Referring to FIG. 5, the vision transformer model learning and inference device 100 may include a learning module 110, a data receiving module 120, a transformed image generating module 130, and an inference module 140.

The learning module 110 may learn a transformer model to minimize the value of a loss function for the difference between a prediction result generated by inputting an original image and a prediction result generated by inputting a transformed image.

The original image may include a plurality of patch images. The transformed image may be generated by removing at least one patch image from the original image.

The learning module 110 may generate a transformed image by removing at least one patch image from an original image including a plurality of patch images.

In one or more embodiments, the learning module 110 may arbitrarily or randomly select and remove at least one patch image from among a plurality of patch images.

In one or more embodiments, the learning module 110 may sequentially generate a plurality of transformed images having a hierarchical structure.

The hierarchical structure may be a structure in which a higher-level transformed image includes more patch images than the lower-level transformed image and includes all patch images included in the lower-level transformed image.

For example, the second level transformed image includes all patch images included in the first level transformed image and further includes several patch images.

In one or more embodiments, the learning module 110 may generate a first level transformed image by removing a plurality of patch images from the original image.

The learning module 110 may generate a second level transformed image in which at least one patch image among a plurality of patch images removed from the first level transformed image is restored.

The learning module 110 may generate a third level transformed image in which at least one patch image among a plurality of patch images removed from the second level transformed image is restored.

The learning module 110 may learn a transformer model that minimizes the value of a loss function for the difference between the result generated by inputting the original image and the result generated by inputting the transformed image.

The learning module 110 may learn a transformer model to minimize values of a loss function representing differences between the result of inputting the original image and the results of respectively inputting a plurality of transformed images having a hierarchical structure.

The learning module 110 may learn the transformer model to minimize the average of the values of the loss function.

The learning module 110 may learn the transformer model using Equation 1 below, for example.

$${E}_{{I}^{′} ∼ T ( I )} [ L ( f ( {I}^{′} ) , y ) ] \qquad Equation 1$$

In Equation 1, E_{I′~T(I)} is the average of the loss function obtained by performing patch image removal, I is the original image, I′ is the transformed image, L is the loss function, f is the result of the transformer model, y is the label and/or inference result of the original image, and T may mean patch removal-based image transformation.

The data receiving module 120 may receive an input image configured of a plurality of patch images, and data including at least one of the device's memory limit and characteristic prior information.

The transformed image generating module 130 may determine a patch image removal criterion for the input image based on the data including the device's memory limit and/or characteristic prior information about the device.

The transformed image generating module 130 may generate a transformed image by dropping (e.g., removing) at least one patch image from the input image according to the determined patch image removal criterion.

The inference module 140 may input the generated transformed image into a pre-learned transformer model and output a prediction result.

Alternatively or additionally, a transformer model according to one or more embodiments may output a trade-off computation speed and inference result based on the number of removals of patches, the removed position, the removal method, and the like of an input transformed image.

Different models may be appropriately selectively used when the computational speed is important and when the inference result (performance) is important.

The vision transformer model learning and inference apparatus 100 appropriately determines the number of patch removals, the removal position, and the removal method of the transformed image when the computational speed is important and when the inference result is important, and inputs them into the pre-learned transformer model.

Therefore, the vision transformer model learning and inference apparatus 100 of one or more embodiments may be flexibility applicable to various devices or environments by using one transformer model.

For example, the vision transformer model learning and inference apparatus 100 of one or more embodiments may be used for semiconductor placement scheduling to enable flexible decision-making between computational load and performance. Alternatively or additionally, the vision transformer model learning and inference apparatus 100 may also be used in CCTV operation time scheduling or speed control scheduling of an autonomous vehicle.

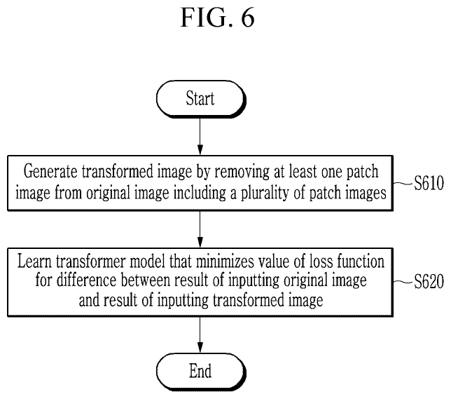

FIG. 6 illustrates a flowchart of a vision transformer model learning method according to one or more embodiments of the present disclosure. The vision transformer model learning method may be performed by the vision transformer model learning and inference apparatus 100 of FIG. 5. The operations of FIG. 6 may be performed in the sequence and manner as illustrated in FIG. 6. However, one or more of the operations may be performed in a different order, one or more of the operations may be omitted, two or more of the operations may be performed in parallel or simultaneously, and/or other operations may be additionally performed without departing from the spirit and scope of the described embodiments.

In FIG. 6, the transformer model learning and inference apparatus 100 may generate a transformed image by removing at least one patch image from an original image including a plurality of patch images (step S610).

The transformer model learning and inference apparatus 100 may learn a transformer model that minimizes the value of a loss function for the difference between the result of inputting an original image and the result of inputting a transformed image (step S620).

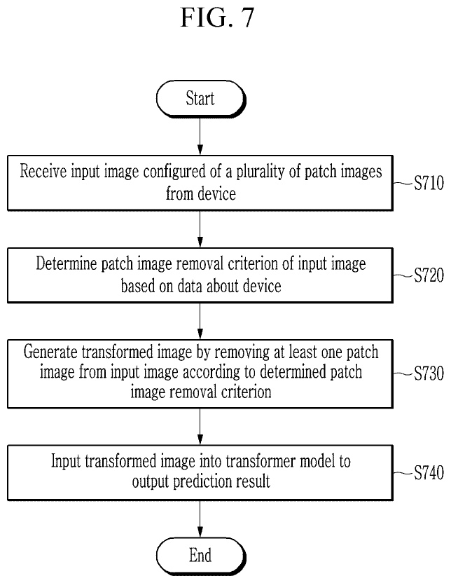

FIG. 7 illustrates a flowchart of a vision transformer model inference method according to one or more embodiments of the present disclosure. The vision transformer model inference method may be performed by the vision transformer model learning and inference apparatus 100 of FIG. 5. The operations of FIG. 7 may be performed in the sequence and manner as illustrated in FIG. 7. However, one or more of the operations may be performed in a different order, one or more of the operations may be omitted, two or more of the operations may be performed in parallel or simultaneously, and/or other operations may be additionally performed without departing from the spirit and scope of the described embodiments.

In FIG. 7, the transformer model learning and inference apparatus 100 may receive an input image configured of a plurality of patch images from the device (step S710).

The transformer model learning and inference apparatus 100 may receive the input image from each of a plurality of devices disposed in a plurality of different processes.

The transformer model learning and inference apparatus 100 may determine a patch image removal criterion of the input image based on data about the device (step S720).

The transformer model learning and inference apparatus 100 may determine how many patch images to remove based on the device's memory data limit.

The transformer model learning and inference apparatus 100 may determine a patch image removal criterion including how many patch images to remove using Equation 2 below, for example.

$$⌈ ( 1 - \sqrt{\frac{m}{M}} ) N ⌉ \qquad Equation 2$$

In Equation 2, N may be the number of reference patch images, M may be the execution memory for the number of reference patch images, and m may be the memory limit of the device.

Alternatively, the transformer model learning and inference apparatus 100 may determine the number of patch images to be removed by identifying the number of limit patch images that may be performed by the device while increasing the number of removed patch images in cases where the device does not have a memory data limit.

The transformer model learning and inference device 100 may determine at least one of the number of removals, the removal position, the removal pattern, and the removal method of the patch image based on prior knowledge data including characteristic information collected in advance for the device.

The transformer model learning and inference apparatus 100 may generate a transformed image by removing at least one patch image from the input image according to the determined patch image removal criterion (step S730).

The transformer model learning and inference apparatus 100 may input the transformed image into the transformer model to output a prediction result (step S740).

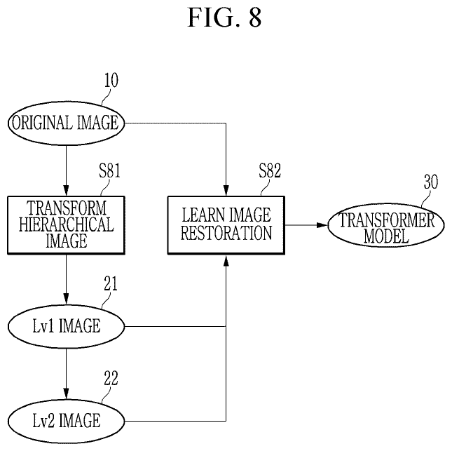

FIG. 8 illustrates a flowchart of a vision transformer model learning method according to one or more embodiments of the present disclosure. The vision transformer model learning method may be performed by the vision transformer model learning and inference apparatus 100 of FIG. 5.

FIG. 8 illustrates a flowchart of a transformer model learning method utilizing the hierarchical structure described with reference to FIG. 4. FIG. 8 illustrates an example using two levels of transformed images.

In FIG. 8, the transformer model learning and inference apparatus 100 may transform the original image 10 into a hierarchical image (step S81).

For example, the transformer model learning and inference apparatus 100 may sequentially generate a plurality of transformed images having a hierarchical structure.

For example, the plurality of transformed images may include a first level transformed image 21 and a second level transformed image 22.

The transformer model learning and inference apparatus 100 may perform image restoration learning with the original image 10, the first level transformed image 21, and the second level transformed image 22 and generate the transformer model 30 (step S82).

In the learning method using the hierarchical structure, the description overlapping that of FIG. 4 is omitted.

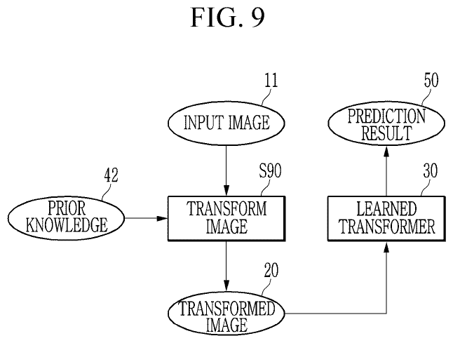

FIG. 9 illustrates a flowchart of a vision transformer model inference method according to one or more embodiments of the present disclosure. The vision transformer model inference method may be performed by the vision transformer model learning and inference apparatus 100 of FIG. 5.

In FIG. 9, the transformer model learning and inference apparatus 100 may determine a patch image removal criterion including at least one of the number of removals, the removal position, the removal pattern, and the removal method of the patch image based on prior knowledge data 42 including characteristic information collected in advance for a device or process.

For example, the transformer model learning and inference apparatus 100 may generate the transformed image 20 with the input image 11 and the prior knowledge data 42 based on the patch image removal criterion determined as described above (step S90).

The transformer model learning and inference apparatus 100 may input the transformed image 20 to the learned transformer model 30 and output a prediction result 50.

For example, the transformer model learning and inference apparatus 100 may collect the difficulty of a problem to be solved by the transformer model in the device as the prior knowledge data 42, and determine the number of removal patch images that are inversely proportional to the difficulty.

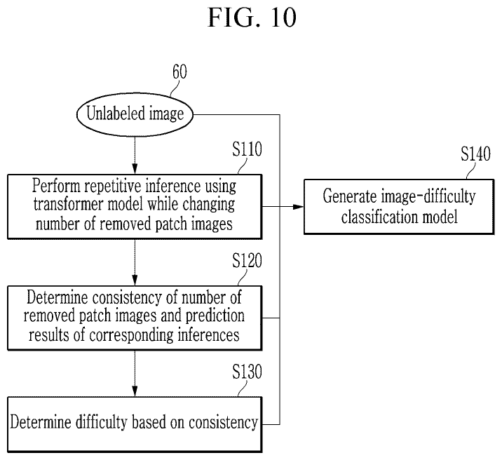

FIG. 10 illustrates a flowchart of a vision transformer model inference method according to one or more embodiments of the present disclosure. The vision transformer model inference method may be performed by the vision transformer model learning and inference apparatus 100 of FIG. 5. The operations of FIG. 10 may be performed in the sequence and manner as illustrated in FIG. 10. However, one or more of the operations may be performed in a different order, one or more of the operations may be omitted, two or more of the operations may be performed in parallel or simultaneously, and/or other operations may be additionally performed without departing from the spirit and scope of the described embodiments.

In FIG. 10, the transformer model learning and inference apparatus 100 may learn the difficulty for an image and determine the number of patch removals.

After the transformer model 30 (see FIG. 1) is learned, the transformer model learning and inference apparatus 100 may determine the prediction difficulty by passing the unlabeled image through the model.

For example, the transformer model learning and inference apparatus 100 may perform repetitive inference using the transformer model while changing the number of removed patch images removed from an unlabeled image 60 (step S110).

The transformer model learning and inference apparatus 100 may determine the consistency of the number of removed patch images and the prediction results of the corresponding inferences (step S120). In an example, the consistency of the prediction results may be a percentage of the prediction results that are a same prediction result.

The transformer model learning and inference apparatus 100 may determine the difficulty based on the consistency (step S130).

The transformer model learning and inference apparatus 100 may determine that the difficulty is low when the transformer model infers consistent results at multiple step removal levels (the number of removed patch images varies for each level), and that the difficulty is high if the opposite is the case (e.g., when the transformer model infers inconsistent or less consistent results at the multiple step removal levels).

The transformer model learning and inference apparatus 100 may learn an image-difficulty classification model based on the determined difficulty (step S140).

Therefore, when an image to be classified is input in the inference process, the transformer model learning and inference apparatus 100 may determine the optimal number of removed patch images by measuring the difficulty using the image-difficulty classification model. For example, in step S140, the transformer model learning and inference apparatus 100 may determine a number of removed patch images resulting in a difficulty being less than or equal to a predetermined threshold to be the optimal number of removed patch images.

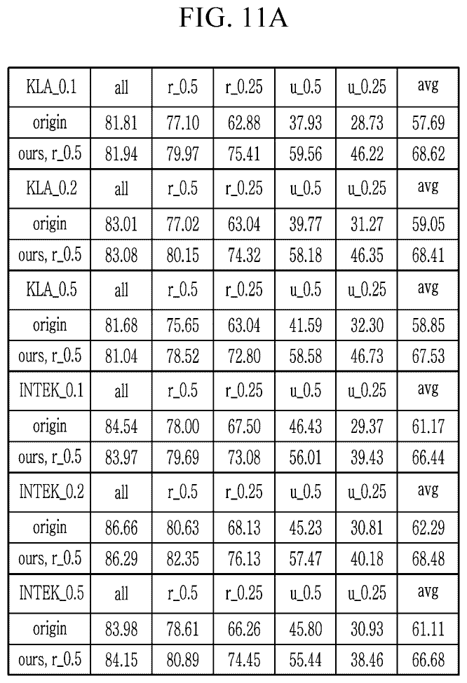

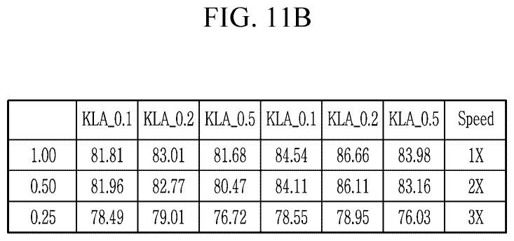

FIG. 11A and FIG. 11B illustrate tables of effects of a vision transformer model apparatus and method according to one or more embodiments of the present disclosure.

FIG. 11A illustrates a table for confirming effects of a representative embodiment used in a semiconductor packaging process.

In FIG. 11A, the table shows the results of applying the algorithm to distinguish about 80 types of defects in a semiconductor packaging process.

The table shows the measurement results (origin) according to existing inspection equipment (KLA, INTEK) and the classification accuracy measurement results (ours) according to one or more embodiments of the present disclosure.

The table records the results of removing patches completely randomly and uniformly.

‘all’ represents the case where the original image is used as is, r_0.5 represents the case where 50% random patch images are used, r_0.25 represents the case where 25% random patch images are used, u_0.5 represents the case where 50% patch images that are uniformly removed according to the patch image removal criteria are used, and u_0.2 represents the case where 25% patch images that are uniformly removed according to the patch image removal criteria are used.

According to the table in FIG. 11a, it can be seen that the measurement results according to one or more embodiments do not show a significant decrease in the measurement results compared to existing inspection equipment. For example, when a transformed image with a patch image removed according to one or more embodiments is used in a learned transformer model, it can be seen that the degree of performance degradation due to patch removal is lower than that of existing equipment.

The time required for the entire learning was about 43 hours for the original and about 20 hours for the method according one or more embodiments, showing that the learning method according to the embodiment is more efficient than the existing method.

FIG. 11B is a table showing the difference between the learning speed according to one or more embodiments and the existing learning speed.

In FIG. 11B, ‘Speed’ means a speed improvement width during inference and represents a speed improvement ratio compared to 1.00 (when the original image is used).

For example, the table shows the performance and speed measurement results for a case where images sensed in a packaging process are images with defective (possibly normal) portions aligned in the center, and where patches are designed to be removed from the outer portion by utilizing prior information according to one or more embodiments.

When only half the actual patches are used (0.50), the performance is almost the same as when all patches are used, but the inference speed is twice as fast. In this case, the memory is used ¼ times.

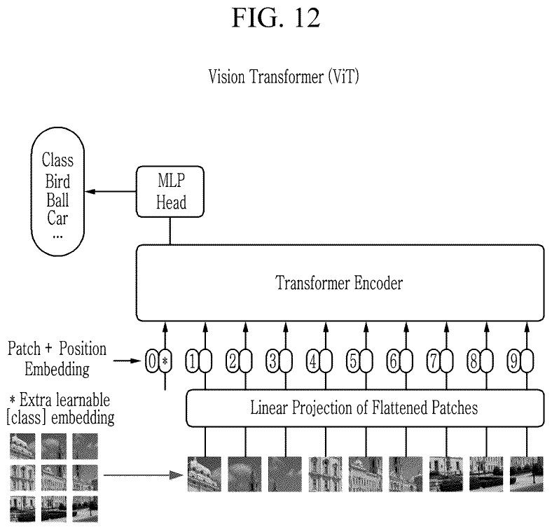

FIG. 12 is a drawing for explaining a typical vision transformer model.

As shown in FIG. 12, a transformer structure may divide an input image into grid-shaped patches and perform computations based on the similarity between respective patches, and since the size of the image divided into patches is fixed, when the characteristics of the input image are changed, the number of patches, the pattern of similarity, and the like may be transformed, and the performance may be significantly reduced.

FIG. 13 is a drawing for explaining a computing device according to one or more embodiments.

Referring to FIG. 13, the vision transformer model learning and inference method and apparatus according to the embodiments may be implemented using a computing device 900.

The computing device 900 may include at least one of a processor 910 (e.g., one or more processors), a memory 930 (e.g., one or more memories), a user interface input device 940, a user interface output device 950, and a storage device 960 in communication through a bus 920. The computing device 900 may also include a network interface 970 electrically connected to the network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), and a neural processing unit (NPU), and may be a semiconductor device that executes instructions stored in the memory 930 or the storage device 960. The processor 910 may be configured to implement the functions and methods described above with reference to FIG. 1 to FIG. 10. For example, the memory 930 may be or include a non-transitory computer-readable storage medium storing instructions that, when executed by the processor 910, configure the processor 910 to perform any one, any combination, or all of the operations and/or methods disclosed herein with reference to FIGS. 1-13.

The memory 930 and the storage device 960 may include various types of volatile or non-volatile storage media. For example, the memory may include a read-only memory (ROM) 931 and a random access memory (RAM) 932. In the present embodiment, the memory 930 may be positioned inside or outside the processor 910, and the memory 930 may be connected to the processor 910 through various known members.

In some embodiments, at least some of the components or functions of the vision transformer model learning and inference method and apparatus according to the embodiments may be implemented as a program or software executed on the computing device 900, and the program or software may be stored in a computer-readable medium.

In some embodiments, at least some of the components or functions of the vision transformer model learning and inference method and apparatus according to the embodiments may be implemented using hardware or circuits of the computing device 900, and/or may be implemented using separate hardware or circuits that may be electrically connected to the computing device 900.

The inference devices, learning modules, data receiving modules, transformed image generating modules, inference modules, computing devices, processors, buses, memories, ROMs, RAMs, user interface input devices, user interface output devices, storage devices, network interfaces, networks, inference device 100, learning module 110, data receiving module 120, transformed image generating module 130, inference module 140, computing device 900, processor 910, bus 920, memory 930, ROM 931, RAM 932, user interface input device 940, user interface output device 950, storage device 960, network 90, and network interface 970 described herein, including descriptions with respect to respect to FIGS. 1-13, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-13 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
removing one or more patch images from an original image comprising a plurality of patch images to generate a transformed image; and
training a transformer model to minimize a value of a loss function for a difference between a result of inputting the original image and a result of inputting the transformed image.

2. The method of claim 1, wherein the removing of one or more patch images from the original image including the plurality of patch images to generate the transformed image comprises randomly selecting and removing one or more patch images from the plurality of patch images.

3. The method of claim 1, wherein the removing of one or more patch images from the original image comprising the plurality of patch images to generate the transformed image comprises:
sequentially generating a plurality of transformed images having a hierarchical structure; and
the hierarchical structure is a structure in which a higher-level transformed image comprises more patch images than a lower-level transformed image and comprises all patch images comprised in the lower-level transformed image.

4. The method of claim 3, wherein the sequentially generating of the plurality of transformed images having the hierarchical structure comprises:
removing a plurality of patch images from the original image to generate a first level transformed image; and
generating a second level transformed image in which one or more patch images are restored from the plurality of patch images removed from the first level transformed image.

5. The method of claim 4, wherein the sequentially generating of the plurality of transformed images having the hierarchical structure further comprises generating a third level transformed image in which one or more patch images are restored from the plurality of patch images removed from the second level transformed image.

6. The method of claim 3, wherein the training of the transformer model that minimizes the value of the loss function for the difference between the result of inputting the original image and the result of inputting the transformed image comprises training the transformer model to minimize values of a loss function representing differences between the result of inputting the original image and results of respectively inputting the plurality of transformed images having the hierarchical structure.

7. The method of claim 1, wherein
the training of the transformer model to minimize the value of the loss function for the difference between the result of inputting the original image and the result of inputting the transformed image comprises training a transformer model using an equation E_{I′~T(I)}[L(ƒ(I′),y)], and
E_{I′~T(I)} is the average of the loss function obtained by performing patch image removal, I is the original image, I′ is the transformed image, L is the loss function, f is the result of the transformer model, y is the label or inference result of the original image, and T is patch removal-based image transformation.

8. The method of claim 1, further comprising
outputting a prediction result for an input image using the trained transformer model,
wherein the outputting of the prediction result for the input image using the trained transformer model comprises:
determining a patch image removal criterion of an input image based on data about a device, the input image comprising a plurality of patch images; and
removing one or more patch images from the input image according to the determined patch image removal criterion to generate a transformed image, and inputting the transformed image to the trained transformer model to output a prediction result.

9. A processor-implemented method comprising:
determining a patch image removal criterion of an input image based on data for a device, the input image comprising a plurality of patch images;
removing one or more patch images from the input image according to the determined patch image removal criterion to generate a transformed image; and
inputting the transformed image into a transformer model to output a prediction result.

10. The method of claim 9, wherein the receiving of the input image configured of the plurality of patch images from the device comprises respectively receiving the input image from a plurality of devices disposed in a plurality of different processes.

11. The method of claim 9, wherein the determining of the patch image removal criterion of the input image based on the data for the device comprises determining the patch image removal criterion comprising one or more of the number of removals of patch images and removal positions of patch images among a plurality of patch images of the input image.

12. The method of claim 9, wherein the determining of the patch image removal criterion of the input image based on the data for the device comprises determining how many patch images to remove based on a memory data limit of the device.

13. The method of claim 12, wherein
the determining of how many patch images to remove based on the memory data limit of the device comprises determining how many patch images to remove using an equation
$$⌈ ( 1 - \sqrt{\frac{m}{M}} ) N ⌉ ,$$
and
N is the number of reference patch images, M is the execution memory for the number of reference patch images, and m is the memory limit of the device.

14. The method of claim 12, wherein the determining of the patch image removal criterion of the input image based on the data for the device further comprises determining how many patch images to remove by finding out the number of executable limit patch images of the device while increasing the number of patch images to be removed in response to the device not having the memory data limit.

15. The method of claim 9, wherein the determining of the patch image removal criterion of the input image based on the data for the device comprises determining the patch image removal criterion comprising any one or any combination of any two or more of a removal number, a removal position, a removal pattern, and a removal method of the patch image, based on prior knowledge data comprising characteristic information previously collected about the device.

16. The method of claim 9, wherein the determining of the patch image removal criterion of the input image based on the data for the device comprises collecting a difficulty of an inference to be performed by the transformer model in the device as prior knowledge data and determining the number of removals of patch images that is inversely proportional to the difficulty.

17. The method of claim 16, wherein the collecting of the difficulty of the inference to be performed by the transformer model in the device as the prior knowledge data and determining the number of removals of the patch images that is inversely proportional to the difficulty comprises:
performing multiple inferences while changing the number of removals of patch images for an arbitrary input image using the transformer model and determining the difficulty based on consistency of predicted results of the inferences;
training an image-difficulty classification model for the device based on the determined difficulty; and
determining the number of removals of patch images for the input image of the device using the trained input image-difficulty classification model.

18. The method of claim 9, further comprising training the transformer model to minimize a value of a loss function for a difference between a first prediction result generated based on an original image comprising a plurality of patch images and a second prediction result generated based on a transformed image generated by removing one or more patch images from the original image.

19. An apparatus comprising:
one or more processors comprising processing circuitry; and
memory comprising one or more storage media storing instructions that, when executed individually or collectively by the one or more processors, cause the electronic device to:
remove one or more patch images from the input image according to a patch image removal criterion determined for the input image based on data to generate a transformed image, the input image comprising a plurality of patch images and the data comprising either one or both of a memory limit and characteristic prior information of the device; and
input the generated transformed image to a transformer model to output a prediction result.

20. The apparatus of claim 19, wherein the transformer model is pre-learned to minimize a value of a loss function for a difference between a first prediction result generated based on an original image comprising a plurality of patch images and a second prediction result generated based on a transformed image generated by removing one or more patch images from the original image.
